(19) United States
(12) Patent Application Publication
(10) Pub. No.: US 2020/0120960 A1
(43) Pub. Date: Apr. 23, 2020

(54) BAKED CHICKEN DREDGED WITH BROWN RICE POWDER AND PRODUCTION METHOD THEREOF

(71) Applicant: OMFOOD CO., LTD., Seoul (KR)

(72) Inventor: Seung Woo PARK, Seoul (KR)

(21) Appl. No.: 16/627,596

(22) PCT Filed: Jul. 17, 2017
(86) PCT No.: PCT/KR2017/007660

§ 371 Date: Dec. 30, 2019

(51) Int. Cl. A23L 5/10; A23L 7/10; A23L 13/60

(52) U.S. Cl. CPC A23L 5/15; A23L 13/62; A23L 7/198

(57) ABSTRACT

Disclosed is a chicken producing method of baking a chicken dredged with brown rice powder. The chicken producing method includes the steps of: washing the chicken; dredging the chicken with the brown rice power; attaching the brown rice powder to the chicken; and baking the chicken.

### TECHNICAL FIELD

The present invention relates to a chicken producing method and a chicken produced thereby, and more particularly, to a backed chicken which is dredged with brown rice powder and a production method thereof.

### BACKGROUND ART

It's not surprising that men and women of all ages enjoy fried chickens, and with recent television drama advertising the product it has fueled the growth of the fried chicken industry.

The effect has caused fierce competition of many fried chicken franchises, resulting in raising the bar of consumer's taste.

A unique cooking method is disclosed by Korean Unexamined Patent Publication No. 10-2015-0060465, entitled ‘Fried chicken and production method thereof’. It does not solve a problem in that a new texture of food is not proposed, and the chicken loses crispness and becomes soggy as time passed.

Accordingly, there is needed a new cooking method improved rather than the conventional production method.

Meanwhile, as recently there has been a growing interest in health, brown rice consumption is increasing. Brown rice is a whole-grain rice with the inedible outer hull removed, and white rice is the same grain with the hull, bran layer and cereal germ removed. That is, people can take in the hull and cereal germ which are removed from the white rice. The hull and the cereal germ include vitamin B1, vitamin B2, Vitamin E, and fiber, in addition to high linoleic acid, which prevents arteriosclerosis or aging.

No method of producing chicken by use of brown rice has been disclosed until now, and thus it is necessary to graft current trends towards health onto the chick production.

The above-described backgrounds are technical information held by the inventor to derive the invention or obtained in the process of deriving the invention, and may not be widely known to those skilled in the art prior to application of the invention.

### DISCLOSURE

### Technical Problem

It is one object of an embodiment of the invention is to prevent chicken from losing crispness and becoming soggy even though time passes.

It is another object of an embodiment of the invention is to provide a new texture of chicken.

It is further another object of an embodiment of the invention is to provide more crispy chicken.

It is further another object of an embodiment of the invention is to allow brown rice power to adhere to chicken well.

It is further another object of an embodiment of the invention is to prevent brown rice powder dredged on chicken from becoming hard in a process of baking the chicken.

It is further another object of an embodiment of the invention is to allow a consumer to take in nutrients contained in hull and cereal germ by use of brown rice.

### Technical Solution

To accomplish the above-mentioned objects, according to the first aspect of the invention, there is provided a chicken producing method of baking a chicken dredged with brown rice powder. The chicken producing method of baking the chicken dredged with the brown rice powder according to the first aspect of the invention includes the steps of: washing the chicken; dredging the chicken with the brown rice power; attaching the brown rice powder to the chicken; and baking the chicken.

According to the second aspect of the invention, there is provided a baked chicken, which is dredged with brown rice powder, produced by the chicken producing method according to the first aspect of the invention including the steps of: washing the chicken; dredging the chicken with the brown rice power; attaching the brown rice powder to the chicken; and baking the chicken.

### Advantageous Effects

According to any one of the technical solutions of the invention, one embodiment of the invention can prevent the chicken from losing crispness and becoming soggy even through time passes.

According to any one of the technical solutions of the invention, one embodiment of the invention can provide a new texture of chicken by exposing particles of the brown rice powder to a skin of the chicken as it is.

According to any one of the technical solutions of the invention, one embodiment of the invention can provide more crispy chicken.

According to any one of the technical solutions of the invention, one embodiment of the invention can allow the brown rice power to adhere to the chicken well.

According to any one of the technical solutions of the invention, one embodiment of the invention can prevent the brown rice powder dredged on the chicken from becoming hard in the process of baking the chicken.

According to any one of the technical solutions of the invention, one embodiment of the invention can allow the consumer to take in nutrients contained in hull and cereal germ by use of the brown rice.

The effects which can be obtained from the invention are not restricted by the above-described effects, and other effects which are not mentioned herein would be apparent from those skilled in the art.

### DESCRIPTION OF DRAWINGS

FIG. 1, FIG. 2, FIG. 3, FIG. 4, FIG. 5, FIG. 6, FIG. 7 and FIG. 8 are flowcharts illustrating a chicken producing method according to preferred embodiments of the invention.

### MODE FOR INVENTION

Hereinafter, preferred embodiments of the invention will be explained in detail in conjunction with the accompanying drawings so that those skilled in the art can easily carry out the present invention. The preferred embodiments of the invention are intended to be illustrative only. Numerous alternative embodiments may be devised by those skilled in the art without departing from the scope of the following claims. In the following description, detailed descriptions of well-known functions or constructions will be omitted since they would obscure the invention in unnecessary detail. The same or equivalent components, members and processes shown in Figures are given the identical reference numerals and the repeated description thereof will be omitted as appropriate.

The terms “comprising” and “including” in the discussion directed to the invention and the claims are used in an open-ended fashion and thus should be interrupted to mean “including”, but not limited thereto.

A chicken producing method of baking chicken dredged with brown rice according to the invention will be described in detail.

According to one embodiment of the invention, the chicken producing method of baking the chicken dredged with the brown rice powder includes the steps of: washing a chicken; dredging the chicken with brown rice powder; attaching the brown rice powder to the chicken; and baking the chicken. In this instance, the step of washing the chicken may include any one of the steps of cutting the chicken, mixing the chicken with a curing agent, and dredging the chicken with powder.

The chicken producing method may further include cutting the chicken. For example, the whole chicken can be cut into several pieces, preferably, 10 to 18 pieces.

The chicken producing method may further include mixing the chicken with the curing agent, and the step of mixing the chicken with the curing agent may include putting the chicken and the curing agent in a tumbler machine and mixing them, and conditioning the chicken mixed with the curing agent.

According to one embodiment of the invention, the tumbler machine rotates at a certain speed to rub the chicken pieces which are inputted with the curing agent. Preferably, the tumbler machine is rotated at a rotating speed of 20 to 30 rpm, and rubs the chicken pieces for about 10 to 15 minutes. The tumbler machine has an effect of easily mixing the chicken and the curing agent and rubbing the chicken pieces to intenerate the meat.

The step of conditioning the chicken may be performed under refrigeration during 24 hours or more.

According to one embodiment of the invention, the chicken producing method may further include battering the chicken with a power paste.

In this instance, the powder paste used at the step of battering the chicken with the powder paste is made by mixing the powder and water, and flour, sugar, starch, rice flour, natural herbs and spices, caster salt and so forth may be added. More specifically, the powder paste is mixed with 3.5 to 4.5% by weight of powder and 3.5 to 4.5% by weight of water for 100% by weight of chicken, while the total weight of the powder paste is within the range of 7 to 9% by weight of chicken. The concentration of the powder results in a batter of a proper thickness, and has viscosity to allow the yellow rice power to be effectively attached.

According to one embodiment of the invention, the step of dredging the chicken with brown rice may be performed on a dedicated worktable for an oven grill. That is, the step of dredging the chicken with brown rice may include dredging the chicken with the brown rice powder, separately from the step of battering the chicken with the powder which is mixed with the water. Through the separate process of dredging the chicken with the brown rice powder, the skin of the chicken is exposed to particles of the brown rice powder as it is, thereby providing a consumer with a new texture of chicken, different from the existing chicken, as well as giving extra crispness. In addition, the chicken produced by the method of the invention proposes an alternative for the conventional deep-fried chicken, and allows the consumer to take in the nutrients contained in the brown rice.

The chicken producing method includes the step of attaching the brown rice powder to the chicken. According to one embodiment of the invention, the step of attaching the brown rice powder to the chicken may include spraying water onto the brown rice powder dredged on the chicken. Through the step of spraying water onto the brown rice powder, it is possible to improve an attaching rate of the brown rice powder, and to prevent the brown rice powder from becoming hard in the process of the process of baking the chicken.

The brown rice powder used at the above processes can be produced by steaming soaked brown rice in a steam cooker, drying the steamed brown rice with hot air in a drier, baking the dried brown rice in a roaster using hot air, and grinding the roasted brown rice to have a desired grain size.

As an example of a preferred amount of the brown rice powder to be dredged on the chicken, 3.5 to 4.5% by weight of the brown rice powder for 100% by weight of the chicken is dredged. The brown rice powder of an excessively large quantity is detached from the chicken to spoil the appearance of the chicken or to be burned. The brown rice powder of an excessively small quantity cannot give new mouthfeel which is pursued by the invention. Accordingly, the objects of the invention can be effectively achieved by dredging the brown rice powder of a proper quantity described above.

The brown rice powder dredged on the chicken has a certain grain size of 1 to 2.5 mm, and according to one embodiment of the invention, the brown rice powder having two grain sizes within the range of 1 to 2.5 mm may be mixed. By dredging the brown rice powder having two grain sizes, it is possible to provide the consumer with diverse textures of chicken.

The step of baking the chicken may further include putting the chicken in an oven and baking the chicken at a temperature of 200 to 240 degrees for 12 to 15 minutes.

The chicken, which is dredged with the brown rice powder, baked by one embodiment of invention includes the chicken which is produced by the chicken producing method of baking the chicken dredged with the brown rice powder, the method including the steps of: washing the chicken; dredging the chicken with brown rice powder; attaching the brown rice powder to the chicken; and baking the chicken.

Preferred embodiments of the invention will now be described in detail with reference to the accompanying drawings.

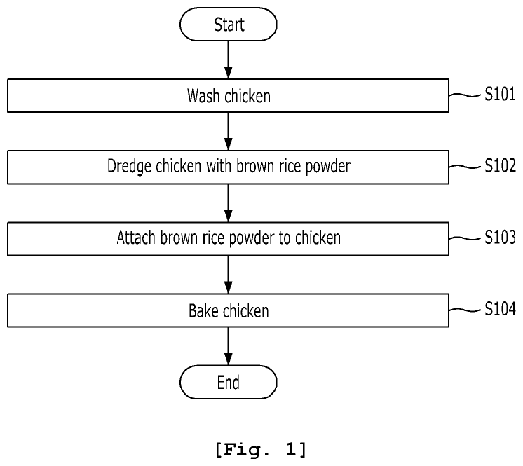

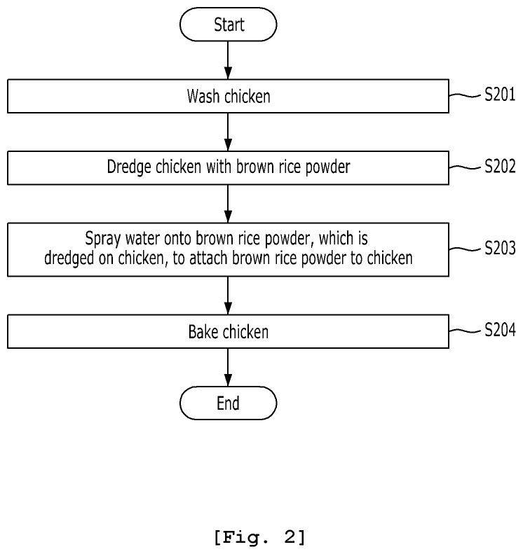

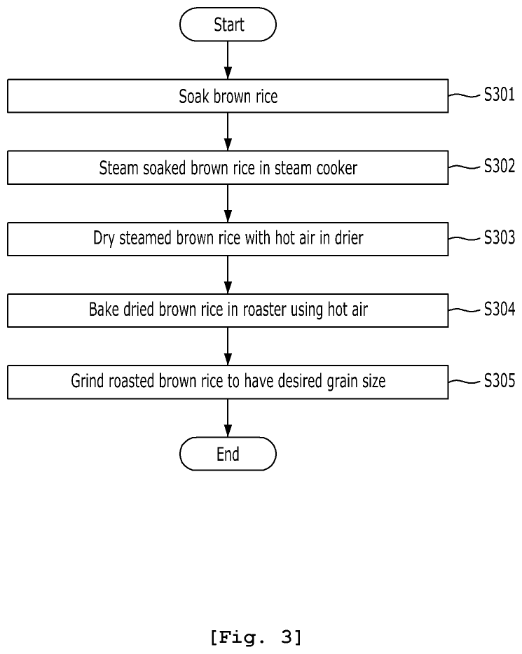

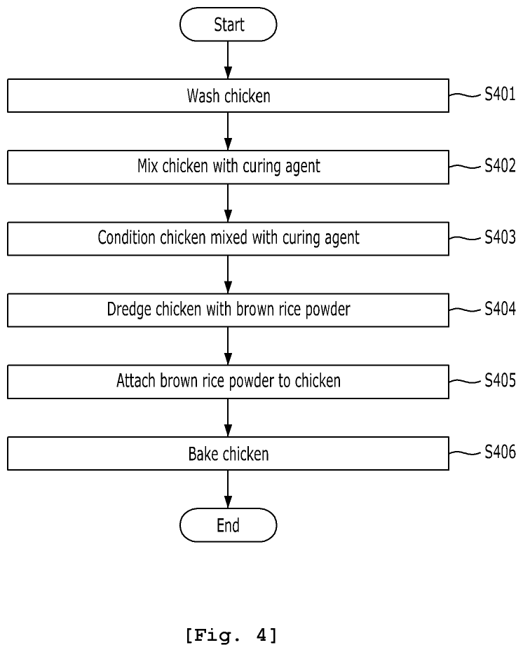

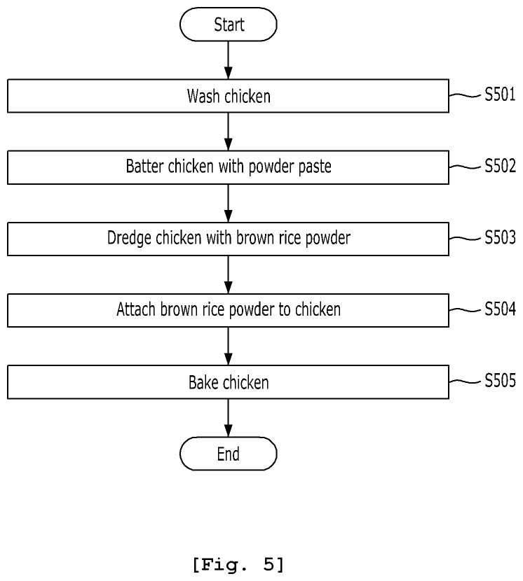

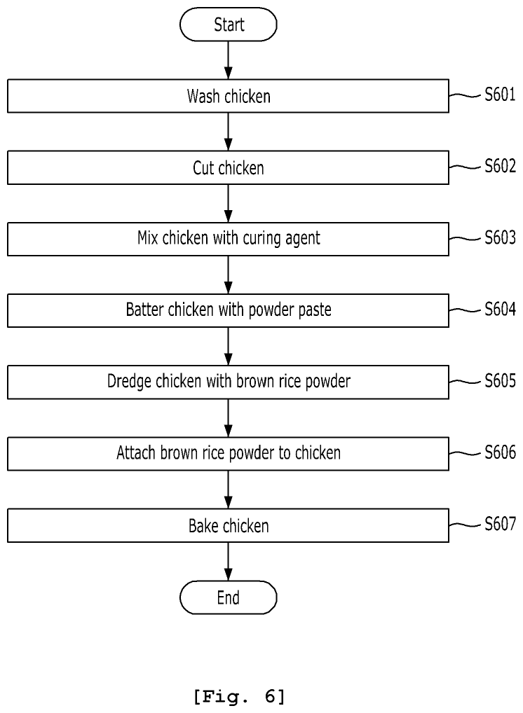

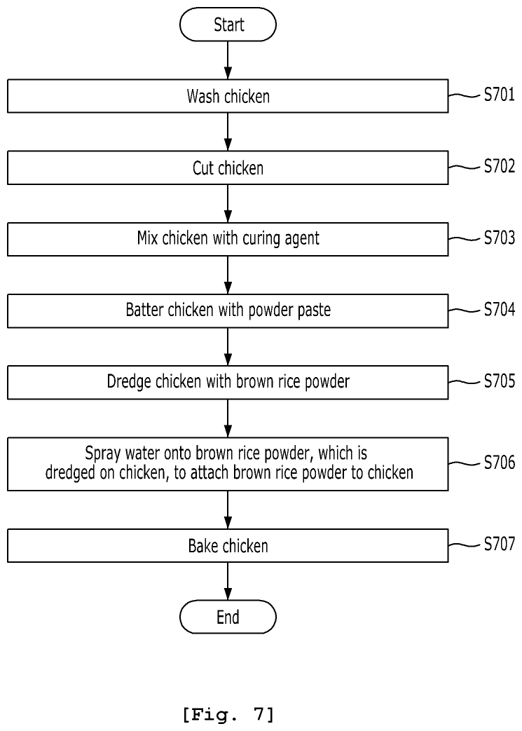

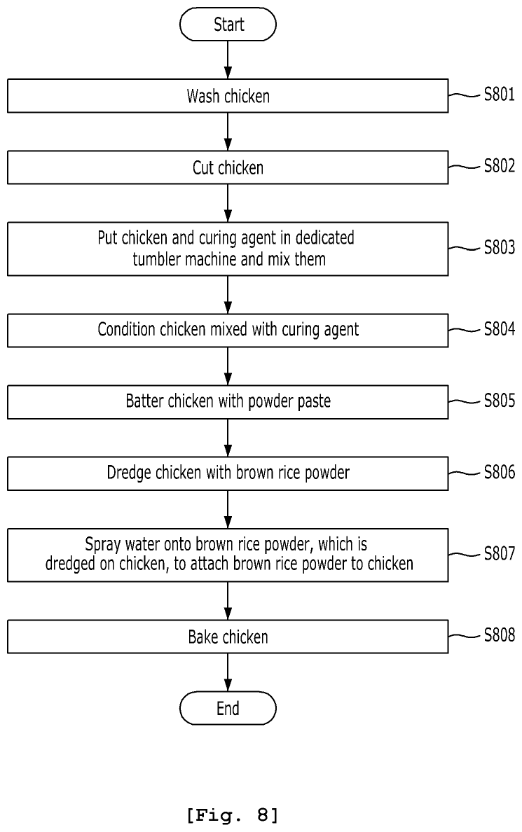

FIGS. 1 to 8 are flowcharts illustrating the chicken producing method of baking the chicken dredged with the brown rice powder according to preferred embodiments of the invention.

Referring to FIG. 1, the chicken producing method of baking the chicken dredged with the brown rice includes a step (S101) of washing the chicken, a step (S102) of dredging the chicken with brown rice powder, a step (S103) of attaching the brown rice powder to the chicken, and a step (S104) of baking the chicken.

Referring to FIG. 2, the chicken producing method of baking the chicken dredged with the brown rice powder includes a step (S201) of washing the chicken, a step (S202) of dredging the chicken with brown rice powder, a step (S203) of attaching the brown rice powder to the chicken, and a step (S204) of baking the chicken. The step (S203) of attaching the brown rice powder to the chicken may include a step of spraying water onto the brown rice powder dredged on the chicken.

In addition, in the chicken producing method of baking the chicken dredged with the brown rice according to one embodiment of the invention which includes the step of washing the chicken, the step of dredging the chicken with brown rice powder, the step of attaching the brown rice powder to the chicken, and the step of baking the chicken, the brown rice powder can be produced by steaming soaked brown rice in a steam cooker, drying the steamed brown rice with hot air in a drier, baking the dried brown rice in a roaster using hot air, and grinding the roasted brown rice to have a desired grain size.

More specifically, as illustrated in FIG. 3, in the chicken producing method of baking the chicken dredged with the brown rice powder the brown rice powder may be produced by a method of producing the brown rice powder, the method including a step (S301) of soaking the brown rice, a step (S302) of steaming the soaked brown rice in a steam cooker, a step (S303) of drying the steamed brown rice with hot air in a drier, a step (S304) of baking the dried brown rice in a roaster using hot air, and a step (S305) of grinding the roasted brown rice to have a desired grain size.

Also, in the chicken producing method of baking the chicken dredged with the brown rice according to one embodiment of the invention which includes the step of washing the chicken, the step of dredging the chicken with brown rice powder the step of attaching the brown rice powder to the chicken, and the step of baking the chicken, the step of attaching the brown rice powder to the chicken may include a step of spraying water onto the brown rice powder dredged on the chicken, and the brown rice powder is produced by steaming soaked brown rice in a steam cooker, drying the steamed brown rice with hot air in a drier, baking the dried brown rice in a roaster using hot air, and grinding the roasted brown rice to have a desired grain size.

In addition, in the chicken producing method of baking the chicken dredged with the brown rice according to one embodiment of the invention which includes the step of washing the chicken, the step of dredging the chicken with brown rice powder the step of attaching the brown rice powder to the chicken, and the step of baking the chicken, the step of attaching the brown rice powder to the chicken may include a step of spraying water onto the brown rice powder dredged on the chicken, and the brown rice powder is produced by steaming soaked brown rice in a steam cooker, drying the steamed brown rice with hot air in a drier, baking the dried brown rice in a roaster using hot air, and grinding the roasted brown rice to have a desired grain size, in which 3.5 to 4.5% by weight of the brown rice powder for 100% by weight of the chicken is dredged.

Furthermore, in the chicken producing method of baking the chicken dredged with the brown rice according to one embodiment of the invention which includes the step of washing the chicken, the step of dredging the chicken with brown rice powder the step of attaching the brown rice powder to the chicken, and the step of baking the chicken, the step of attaching the brown rice powder to the chicken may include a step of spraying water onto the brown rice powder dredged on the chicken, and the brown rice powder is produced by steaming soaked brown rice in a steam cooker, drying the steamed brown rice with hot air in a drier, baking the dried brown rice in a roaster using hot air, and grinding the roasted brown rice to have two grain sizes.

Furthermore, in the chicken producing method of baking the chicken dredged with the brown rice according to one embodiment of the invention which includes the step of washing the chicken, the step of dredging the chicken with brown rice powder the step of attaching the brown rice powder to the chicken, and the step of baking the chicken, the step of attaching the brown rice powder to the chicken may include a step of spraying water onto the brown rice powder dredged on the chicken, and the brown rice powder is produced by steaming soaked brown rice in a steam cooker, drying the steamed brown rice with hot air in a drier, baking the dried brown rice in a roaster using hot air, and grinding the roasted brown rice to have two grain sizes, in which 3.5 to 4.5% by weight of the brown rice powder for 100% by weight of the chicken is dredged.

Meanwhile, referring to FIG. 4, the chicken producing method of baking the chicken dredged with the brown rice may include a step (S401) of washing the chicken, a step (S402) of mixing the chicken with a curing agent, a step (S404) of dredging the chicken with brown rice powder a step (S405) of attaching the brown rice powder to the chicken, and a step (S406) of baking the chicken. The step (S402) of mixing the chicken with the curing agent may include a step of putting the chicken and the curing agent in a tumbler machine and mixing them, and a step (S403) of conditioning the chicken mixed with the curing agent.

Also, referring to FIG. 5, the chicken producing method of baking the chicken dredged with the brown rice may include a step (S501) of washing the chicken, a step (S502) of battering the chicken with a power paste, a step (S503) of dredging the chicken with brown rice powder a step (S504) of attaching the brown rice powder to the chicken, and a step (S505) of baking the chicken. In this instance, the powder paste is mixed with 3.5 to 4.5% by weight of powder and 3.5 to 4.5% by weight of water for 100% by weight of chicken, while the total weight of the powder paste is within the range of 7 to 9% by weight of chicken.

In addition, referring to FIG. 6, the chicken producing method of baking the chicken dredged with the brown rice may include a step (S601) of washing the chicken, a step (S602) of cutting the chicken, a step (S603) of mixing the chicken with the curing agent, a step (S604) of battering the chicken with a power paste, a step (S605) of dredging the chicken with brown rice powder a step (S606) of attaching the brown rice powder to the chicken, and a step (S607) of baking the chicken.

Furthermore, referring to FIG. 7, the chicken producing method of baking the chicken dredged with the brown rice may include a step (S701) of washing the chicken, a step (S702) of cutting the chicken, a step (S703) of mixing the chicken with the curing agent, a step (S704) of battering the chicken with a power paste, a step (S705) of dredging the chicken with brown rice powder a step (S706) of attaching the brown rice powder to the chicken, and a step (S707) of baking the chicken. The step (S706) of attaching the brown rice powder to the chicken may include a step of spraying water onto the brown rice powder dredged on the chicken.

Also, according to one embodiment of the invention, the chicken producing method of baking the chicken dredged with the brown rice may include a step of washing the chicken, a step of cutting the chicken, a step of mixing the chicken with the curing agent, a step of battering the chicken with a power paste, a step of dredging the chicken with brown rice powder a step of attaching the brown rice powder to the chicken, and a step of baking the chicken. The brown rice powder is produced by steaming soaked brown rice in a steam cooker, drying the steamed brown rice with hot air in a drier, baking the dried brown rice in a roaster using hot air, and grinding the roasted brown rice to have a desired grain size.

In addition, according to one embodiment of the invention, the chicken producing method of baking the chicken dredged with the brown rice may include a step of washing the chicken, a step of cutting the chicken, a step of mixing the chicken with the curing agent, a step of battering the chicken with a power paste, a step of dredging the chicken with brown rice powder a step of attaching the brown rice powder to the chicken, and a step of baking the chicken. The brown rice powder is produced by steaming soaked brown rice in a steam cooker, drying the steamed brown rice with hot air in a drier, baking the dried brown rice in a roaster using hot air, and grinding the roasted brown rice to have a desired grain size. The step of attaching the brown rice powder to the chicken may include a step of spraying water onto the brown rice powder dredged on the chicken, and the brown rice powder is produced by steaming soaked brown rice in a steam cooker, drying the steamed brown rice with hot air in a drier, baking the dried brown rice in a roaster using hot air, and grinding the roasted brown rice to have a desired grain size.

Meanwhile, referring to FIG. 8, the chicken producing method of baking the chicken dredged with the brown rice may include a step (S801) of washing the chicken, a step (S802) of cutting the chicken, a step (S803) of mixing the chicken with the curing agent, a step (S805) of battering the chicken with a power paste, a step (S806) of dredging the chicken with brown rice powder a step (S807) of attaching the brown rice powder to the chicken, and a step (S808) of baking the chicken. The step (S803) of mixing the chicken with the curing agent may include a step of putting the chicken and the curing agent in a dedicated tumbler machine and mixing them, and a step (S804) of conditioning the chicken mixed with the curing agent. The dedicated tumbler machine rotates at a certain speed to rub the chicken pieces which are inputted with the curing agent. The powder paste is mixed with 3.5 to 4.5% by weight of powder and 3.5 to 4.5% by weight of water for 100% by weight of chicken, while the total weight of the powder paste is within the range of 7 to 9% by weight of chicken. The step (807) of attaching the brown rice powder to the chicken may include a step of spraying water onto the brown rice powder dredged on the chicken, and the brown rice powder is produced by steaming soaked brown rice in a steam cooker, drying the steamed brown rice with hot air in a drier, baking the dried brown rice in a roaster using hot air, and grinding the roasted brown rice to have a desired grain size.

Also, according to one embodiment of the invention, the chicken producing method of baking the chicken dredged with the brown rice may include a step of washing the chicken, a step of cutting the chicken, a step of mixing the chicken with the curing agent, a step of battering the chicken with a power paste, a step of dredging the chicken with brown rice powder a step of attaching the brown rice powder to the chicken, and a step of baking the chicken. The step of mixing the chicken with the curing agent may include a step of putting the chicken and the curing agent in a dedicated tumbler machine and mixing them, and a step of conditioning the chicken mixed with the curing agent. The dedicated tumbler machine rotates at a certain speed to rub the chicken pieces which are inputted with the curing agent. The powder paste is mixed with 3.5 to 4.5% by weight of powder and 3.5 to 4.5% by weight of water for 100% by weight of chicken, while the total weight of the powder paste is within the range of 7 to 9% by weight of chicken. The step of attaching the brown rice powder to the chicken may include a step of spraying water onto the brown rice powder dredged on the chicken, and the brown rice powder is produced by steaming soaked brown rice in a steam cooker, drying the steamed brown rice with hot air in a drier, baking the dried brown rice in a roaster using hot air, and grinding the roasted brown rice to have two grain sizes, in which 3.5 to 4.5% by weight of the brown rice powder for 100% by weight of the chicken is dredged.

In addition, according to one embodiment of the invention, the chicken producing method of baking the chicken dredged with the brown rice may include a step of washing the chicken, a step of cutting the chicken, a step of mixing the chicken with the curing agent, a step of battering the chicken with a power paste, a step of dredging the chicken with brown rice powder a step of attaching the brown rice powder to the chicken, and a step of baking the chicken. The step of mixing the chicken with the curing agent may include a step of putting the chicken and the curing agent in a dedicated tumbler machine and mixing them, and a step of conditioning the chicken mixed with the curing agent. The dedicated tumbler machine rotates at a certain speed to rub the chicken pieces which are inputted with the curing agent. The powder paste is mixed with 3.5 to 4.5% by weight of powder and 3.5 to 4.5% by weight of water for 100% by weight of chicken, while the total weight of the powder paste is within the range of 7 to 9% by weight of chicken. The step of attaching the brown rice powder to the chicken may include a step of spraying water onto the brown rice powder dredged on the chicken, and the brown rice powder is produced by steaming soaked brown rice in a steam cooker, drying the steamed brown rice with hot air in a drier, baking the dried brown rice in a roaster using hot air, and grinding the roasted brown rice to have two grain sizes, in which 3.5 to 4.5% by weight of the brown rice powder for 100% by weight of the chicken is dredged. The step of baking the chicken may further include putting the chicken in an oven and baking the chicken at a temperature of 200 to 240 degrees for 12 to 15 minutes.

While the invention has been described with reference to the particular illustrative embodiments, it is not to be restricted by the embodiments but only by the appended claims. It is to be appreciated that those skilled in the art can change or modify the embodiments without departing from the scope and spirit of the present invention. The above described embodiments of the invention are intended to be illustrative only. Numerous alternative embodiments may be devised by those skilled in the art without departing from the scope of the following claims. For example, the respective components described in a singular form may be installed in a plural form, or the respective components described in a plural form may be integrated with a single component.

The scope of the invention is not defined by the detailed description of the invention, but is defined by the following claims. The present invention may be varied or modified without departing from the spirit or scope defined by the appended claims. Of course, equivalents thereof are contained in the present invention.

### INDUSTRIAL APPLICABILITY

The invention relates to the chicken producing method and the chicken produced by the same, and the baked chicken which is dredged with the brown rice powder, and the production method thereof can be available in the industrial field.

1. A chicken producing method of baking a chicken dredged with brown rice powder, the chicken producing method comprising the steps of:
washing the chicken;
dredging the chicken with the brown rice power;
attaching the brown rice powder to the chicken; and
baking the chicken.

2. The chicken producing method according to claim 1, further comprising a step of cutting the chicken.

3. The chicken producing method according to claim 1, further comprising a step of mixing the chicken with a curing agent.

4. The chicken producing method according to claim 1, further comprising a step of battering the chicken with a powder paste.

5. The chicken producing method according to claim 3, wherein the step of mixing the chicken with the curing agent includes a step of putting the chicken and the curing agent in a dedicated tumbler machine and mixing them, and a step of conditioning the chicken mixed with the curing agent, and
the tumbler machine rotates at a certain speed to rub the chicken pieces which are inputted with the curing agent.

6. The chicken producing method according to claim 4, wherein the powder paste is mixed with 3.5 to 4.5% by weight of powder and 3.5 to 4.5% by weight of water for 100% by weight of chicken, while the total weight of the powder paste is within a range of 7 to 9% by weight of chicken.

7. The chicken producing method according to claim 1, wherein the step of attaching the brown rice powder to the chicken includes a step of spraying water onto the brown rice powder dredged on the chicken.

8. The chicken producing method according to claim 1, wherein the brown rice powder is produced by steaming soaked brown rice in a steam cooker, drying the steamed brown rice with hot air in a drier, baking the dried brown rice in a roaster using hot air, and grinding the roasted brown rice to have a desired grain size.

9. The chicken producing method according to claim 1, wherein a weight of the brown rice powder is within a range of 3.5 to 4.5% by weight relative to a weight of the chicken.

10. The chicken producing method according to claim 1, wherein the brown rice powder is mixed with two brown rice powder of different grain sizes.

11. The chicken producing method according to claim 1, wherein the step of baking the chicken includes a step of putting the chicken in an oven and baking the chicken at a temperature of 200 to 240 degrees for 12 to 15 minutes.

12. A baked chicken, which is dredged with brown rice powder, produced by the chicken producing method set forth in claim 1.
